(19) United States
(12) Patent Application Publication
(10) Pub. No.: US 2016/0171420 A1
(43) Pub. Date: Jun. 16, 2016

(54) OPTIMIZING ALLOCATION OF EMPLOYEES FOR CORPORATE TRAINING

(71) Applicant: International Business Machines Corporation, Armonk, NY (US)

(72) Inventor: Hisham El-Shishiny, El-Ahram Giza (EG)

(21) Appl. No.: 14/568,354

(22) Filed: Dec. 12, 2014

(51) Int. Cl. G06Q 10/06; G09B 5/00; G09B 19/00

(52) U.S. Cl. CPC G06Q 10/063118; G09B 19/00; G09B 5/00

(57) ABSTRACT

Methods and apparatuses for allocating employees to training is provided. A processor receives a plurality of offered courses for training. A processor receives a first constraint for allocating employees to training, wherein the first constraint includes a first training budget for a first business unit and a second training budget for a second business unit. A processor determines a number of employees of the first business unit and a number of employees of the second business unit to be allocated to at least one of the plurality of offered courses based, at least in part, on the first training budget and the second training budget.

### BACKGROUND OF THE INVENTION

The present invention relates generally to the field of corporate training, and more particularly to optimizing the allocation of employees based on resources.

Corporate training refers to a system of professional development activities provided to educate employees. Many corporations provide corporate training to train their employees on specific aspects of their job processes or responsibilities. Corporations offer training to maintain and improve professional competence, to promote career progression, to keep abreast of new technology and practices, or to comply with professional regulatory organizations. By providing such training opportunities, not only do corporations improve the quality of its workforce but it also improves the work products or service the employees themselves provide.

### SUMMARY

According to one embodiment of the present disclosure, a method for allocating employees to training is provided. The method includes receiving a plurality of offered courses for training. Receiving a first constraint for allocating employees to training, wherein the first constraint includes a first training budget for a first business unit and a second training budget for a second business unit. Determining a number of employees of the first business unit and a number of employees of the second business unit to be allocated to at least one of the plurality of offered courses based, at least in part, on the first training budget and the second training budget.

According to another embodiment of the present disclosure, a computer program product allocating employees to training is provided. The computer program product comprises a computer readable storage medium and program instructions stored on the computer readable storage medium. The program instructions include program instructions to receive a plurality of offered courses for training. Program instructions to receive a first constraint for allocating employees to training, wherein the first constraint includes a first training budget for a first business unit and a second training budget for a second business unit. Program instructions to determine a number of employees of the first business unit and a number of employees of the second business unit to be allocated to at least one of the plurality of offered courses based, at least in part, on the first training budget and the second training budget.

According to another embodiment of the present disclosure, a computer system for allocating employees to training is provided. The computer system includes one or more computer processors, one or more computer readable storage media, and program instructions stored on the computer readable storage media for execution by at least one of the one or more processors. The program instructions include program instructions to receive a plurality of offered courses for training. Program instructions to receive a first constraint for allocating employees to training, wherein the first constraint includes a first training budget for a first business unit and a second training budget for a second business unit. Program instructions to determine a number of employees of the first business unit and a number of employees of the second business unit to be allocated to at least one of the plurality of offered courses based, at least in part, on the first training budget and the second training budget.

### BRIEF DESCRIPTION OF THE SEVERAL VIEWS OF THE DRAWINGS

FIG. 1 is a functional block diagram illustrating a scheduling environment, in accordance with an exemplary embodiment of the present invention.

FIGS. 2A and 2B illustrate operational processes of a scheduling program, on a computing device within the environment of FIG. 1, in accordance with an exemplary embodiment of the present invention.

FIG. 3 depicts a block diagram of components of the computing device executing a scheduling program, in accordance with an exemplary embodiment of the present invention.

### DETAILED DESCRIPTION

While solutions to scheduling corporate training are known, they do not take into considerations the resources and plans a business may have in regards to training. Specifically current solutions do not take into consideration training budgets or other types of restrictions a corporation may have and require manual alteration by managers to meet corporate goals. Embodiments of the present invention recognize that by providing an automated system to generate an enrollment plan of employees while satisfying the constraints a business has in regards to training, an optimal solution to scheduling corporate training can be achieved.

For larger organizations, training courses may be offered at a variety of venues. Each venue may have different costs associated with offering a training course and, for employees whose reporting or home location is at a location other than where the training is offered, a travel cost affects the overall budget allocated for training. Based on these known costs and budgets, embodiments of the present invention provide solutions to generate an optimal allocation plan of employees from different locations to training offered at a variety of venues. Furthermore, embodiments of the present invention provide solutions to allow constraints such as training budgets to be separated into components such as business units to provide a more granular solution to enrollment to corporate training.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

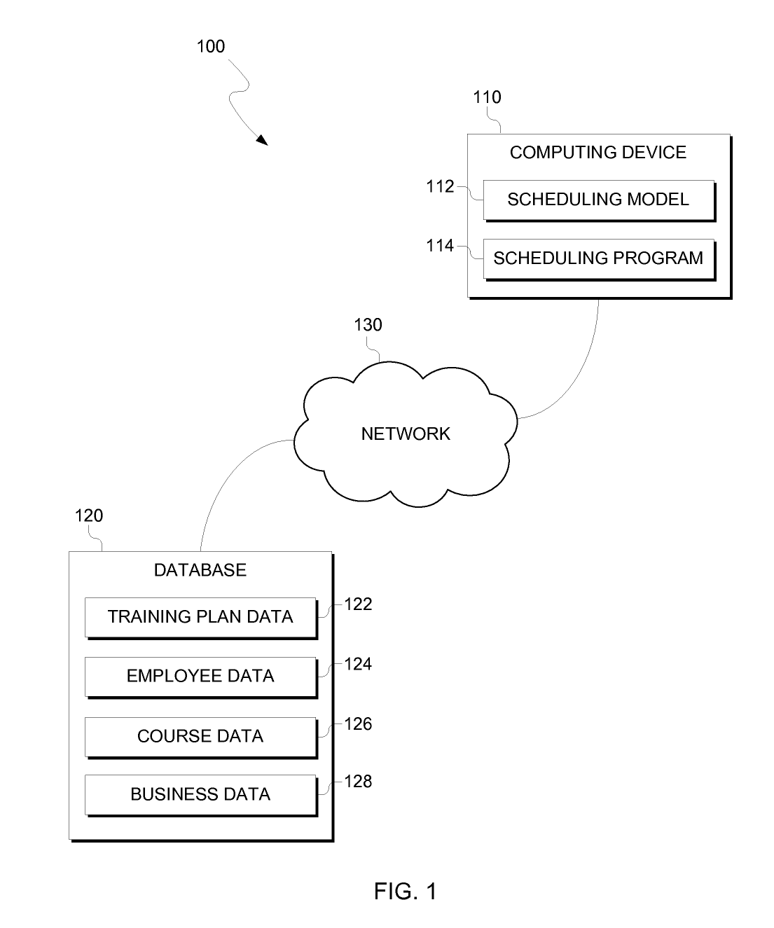

The present invention will now be described in detail with reference to the Figures. FIG. 1 is a functional block diagram illustrating a scheduling environment, generally designated 100, in accordance with one embodiment of the present invention. Scheduling environment 100 includes computing device 110 and database 120 connected over network 130. Computing device 110 includes scheduling model 112 and scheduling program 114. Database 120 includes training plan data 122, employee data 124, course data 126 and business data 128.

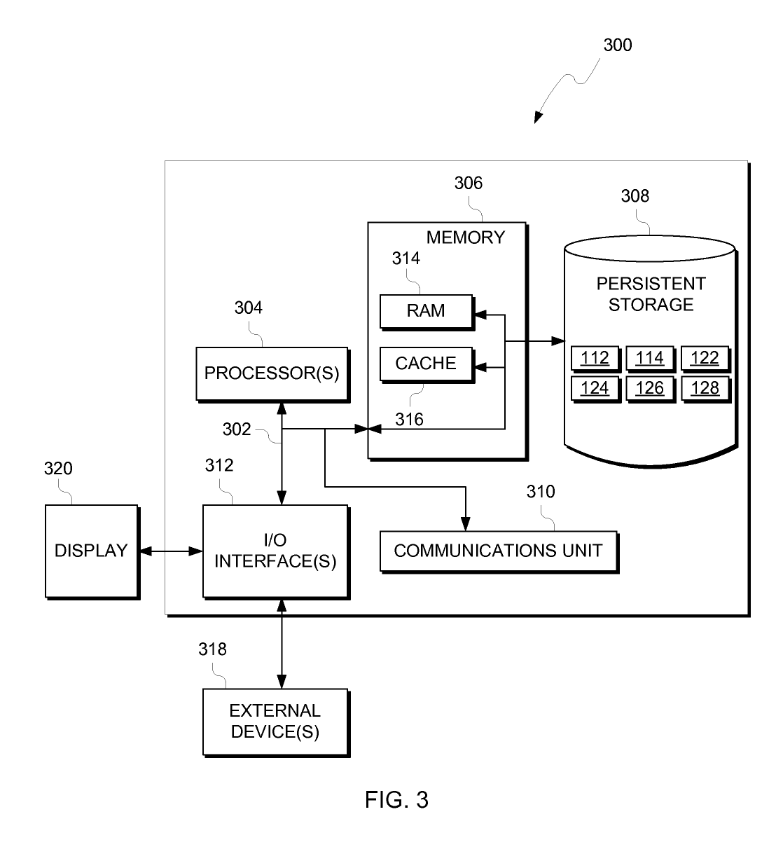

In various embodiments of the present invention, computing device 110 and database 120 each are computing devices that can be a standalone device, a server, a laptop computer, a tablet computer, a netbook computer, a personal computer (PC), or a desktop computer. In another embodiment, computing device 110 and database 120 each represent a computing system utilizing clustered computers and components to act as a single pool of seamless resources. In general, computing device 110 and database 120 each can be any computing device or a combination of devices with access to scheduling model 112, training plan data 122, employee data 124, course data 126 and business data 128 and is capable of executing scheduling program 114. Computing device 110 and database 120 may each include internal and external hardware components, as depicted and described in further detail with respect to FIG. 3.

In this exemplary embodiment, scheduling model 112 and scheduling program 114 are stored on computing device 110. Training plan data 122, employee data 124, course data 126 and business data 128 are stored on database 120. However, in other embodiments, scheduling model 112, scheduling program 114, training plan data 122, employee data 124, course data 126 and business data 128 may be stored externally and accessed through a communication network, such as network 130. Network 130 can be, for example, a local area network (LAN), a wide area network (WAN) such as the Internet, or a combination of the two, and may include wired, wireless, fiber optic or any other connection known in the art. In general, network 130 can be any combination of connections and protocols that will support communications between computing device 110 and database 120, in accordance with a desired embodiment of the present invention.

In various embodiments, scheduling program 114 determines an allocation to training courses for employees of a business or organization. In one embodiment, scheduling program 114 determines the allocation based on training information and constraints. For example, training information includes offered courses, the time and location of the offered courses, available training budgets (e.g., business-wide, per business unit or per department), cost of enrolling an employee for training, among other types of training information described in detail herein. A constraint is either pre-defined or user defined. An example constraint ensures that a determined allocation for one or more courses does not exceed the allocation of a business units training budget. Example constraints are described in more detail in the herein. Scheduling program 114 optimizes a function (i.e., an objective function), either pre-defined or user defined, based on the training information and constraints. For example, scheduling program 114 maximizes the number of employees enrolled in training courses while said enrollment is within the constraints based on a set of training information.

In various embodiments, scheduling program 114 stores and retrieves constraints and an objective function in scheduling model 112. Scheduling program 114 receives input from a user to select the constraints and an objective function based on the selected constraints, when determining an allocation. Constraints and objective functions are defined based on constants and variables, where variables represent the unknown quantities that need to be determined to optimize the objective function (also called decision variables), such as the number of employees allocated to each offered course from each business unit and location. Constants (also known as coefficients) refer to training information and resource availabilities stored in database 120. For example, a constant may be the maximum number of seats for a particular course at a particular location. An objective function is a function including variables and constants that scheduling program 114 will maximize or minimize subject to one or more constraints. Based on the values used in the variables, the value computed for the objective function changes. Scheduling program 114 determines a combination of the variables that produces the maximum or minimum value of the objective function. A constraint is an equation or inequality that restricts (or constrains) the possible values that the variables can take, and that scheduling program 114 must keep true when maximizing or minimizing the objective function. In some embodiments, a user adds, removes or edits an objective function and/or a constraint to include in scheduling model 112. Scheduling program 114 receives input from a user to add an objective function and/or constraints to scheduling model 112. Scheduling program 114 updates scheduling model 112 based on the input received by the user. In various embodiments, scheduling model 112 includes any objective functions and constraints, either pre-defined or user defined, to be used by scheduling program 114 when determining an allocation. Scheduling program 114 receives input from a user, prior to determining an allocation, as to which objective function and constraints stored in scheduling model 112 to be used by scheduling program 114. Scheduling program 114 receives input from a user indicating the type of optimization that the user wants to be performed for the objective function. For example, the user indicates the objective function is to be maximized or minimized.

In various embodiments, scheduling program 114 determines an allocation of employees based on an optimization algorithm. For example, scheduling program 114 performs a linear optimization algorithm to determine an allocation. The linear optimization algorithm bases the determination on the selected objective function, whether to maximize or minimize the objective function, subject to the selected constraints and based on training information used as constants (also called coefficients), as well as the variables represented in the objective function and the selected constraints. The linear optimization algorithm calculates a feasibility region based on the intersection of the constraints using training information stored in database 120. A feasibility region is a set of points in a multidimensional space that satisfies all constraints. Based on the points found in the feasibility region, scheduling program 114 determines a set of points that maximizes or minimizes the objective function. Example constraints include a constraint that the number of employees allocated for training for a course do not exceed the maximum number of seats allocated for the course and the cost for enrolling employees for a business unit does not exceed the training budget for the business unit. One of ordinary skill in the art will appreciate that any optimization algorithm may be used, given the algorithm maximizes or minimizes an objective function based on one or more constraints. In various embodiments, scheduling program 114 determines an optimal allocation based on the optimized objective function and the training information. For example, an optimized mixture of a number of employees from various business units and locations is determined by an optimization algorithm. Scheduling program 114 determines which employees to allocate from the business units and locations, based on an availability of the employees for training.

In various embodiments, database 120 stores training information. Scheduling program 114 retrieves information from database 120 to determine constants of the constraints stored in scheduling model 112. Constraints are defined using references to training information stored database 120 in addition to indices for specific values stored in training information. For example, a constant in a constraint refers to the maximum number of total seats for a given course, and a variable represents an unknown, such as the number of employees allocated to each offered course from each business unit and location, that needs to be determined to optimize the objective function. The variable may change based on multiple types of information. Such as by a course identifier and a location, as a similar course may be offered at two different locations. In various embodiments, database 120 includes training plan data 122, employee data 124, course data 126 and business data 128. Training plan data 122 includes training plans for employees that include either recommended or required training courses for an employee. Employee data 124 includes information describing an employee such as the employee's business unit, location, manager, courses previously attended by the employee and any travel restrictions the employee may have (e.g., countries the employee cannot obtain visas to travel to). Course data 126 includes a list of courses offered across multiple locations, times and dates when the courses are offered, or any reservations for employees from a specific business unit (e.g., a number of seats reserved for a business unit). Business data 128 includes a budget for training of different business units and travel costs to and from each location.

In some embodiments, training plan data 122, employee data 124, course data 126 and business data 128 are stored in database 120. In other embodiments, training data 122, employee data 124, course data 126 and/or business data 128 are stored in one or more databases. In another embodiment, training plan data 122, employee data 124, course data 126 and/or business data 128 are stored locally in computing device 110. In further embodiments, training plan data 122, employee data 124, course data 126 and/or business data 128 are each stored across multiple devices of network 130. For example, employee data 124 for employees of one business unit are stored in a device at a first location and employee data 124 for employees of another business unit are stored in a device at a second location.

In various embodiments, scheduling program 114 receives input from a user regarding the location of training plan data 122, employee data 124, course data 126 and/or business data 128. For example, a user provides scheduling program 114 with a location of a database or device connected to network 130. In other embodiments, scheduling program 114 receives input from the user regarding the information represented by training plan data 122, employee data 124, course data 126 and/or business data 128. For example, scheduling program 114 provides a user interface to receive information regarding corporate training (e.g., course schedules, business units' budgets) from a user via an input device connected to computing device 110.

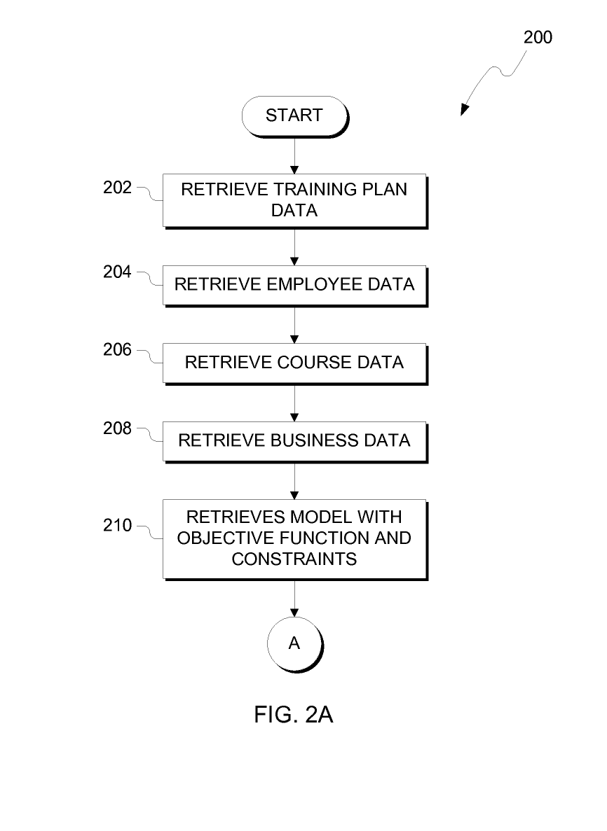

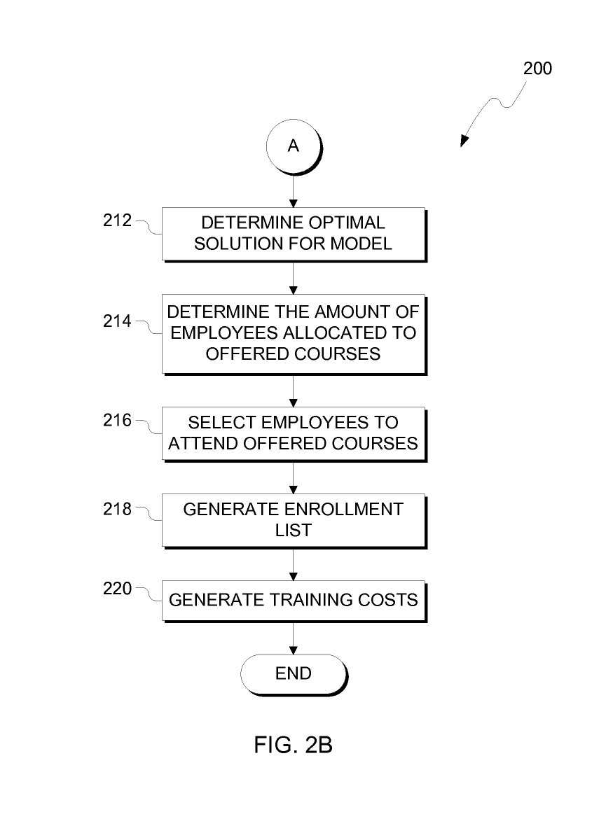

FIGS. 2A and 2 B include a flowchart illustrating operational processes, generally designated 200, of scheduling program 112 for determining an allocation of employees for training, on a computing device within the environment of FIG. 1, in accordance with an exemplary embodiment of the present invention. In process 202, scheduling program 114 retrieves training plan data 122. Training plan data 122 includes entries for one or more employees indicating one or more required or recommended courses for the employee. In some embodiments, a manager of an employee selects the required or recommended courses. In other embodiments, the required or recommended courses are determined based on the position or career track that a particular employee is assigned. In various embodiments, an entry in training plan data 122 includes (i) an employee identification number or name of the employee; (ii) any required or recommended courses for the employee; and (iii) whether the employee has previously taken the required or recommended courses of training plan data 122. In an embodiment, training plan data 122 includes a track or path of progression of courses required to be taken to complete the track. For example, an entry of training plan data 122 includes one or more prerequisite courses required to be taken before a particular course in training plan data 122 is to be taken by an employee.

In process 204, scheduling program 114 retrieves employee data 124. In various embodiments, employee data 124 includes entries for one or more employees describing an employee. An entry in employee data 124 includes (i) an employee identification number or name of the employee; (ii) a home or reporting location where the employee works; (iii) an address or location of the employees residence; (iv) a business unit or department that the employee works under; and (v) a manger of the employee (e.g., the name of the manager or an identification number of the manger). In some embodiments, employee data 124 also includes travel restrictions associated with an employee. For example, employee data 124 includes one or more countries or locations that the employee is unable to travel to, such as visa restrictions based on the home address or reporting location of an employee. In some embodiments, employee data 124 includes the time and/or dates an employee is available for training. For example, an employee provides one or more pairs of start dates and end dates for days the employee is available for training. The provided availability is stored in the entry for the employee in employee data 124. In some embodiments, availability may be predetermined based on the home or reporting location of an employee or the business unit of the employee. In an embodiment, a manger of the employee provides the availability for training of the employee.

In process 206, scheduling program 114 retrieves course data 126. In various embodiments, course data 126 includes entries for various courses offered to employees of the organization. An entry in course data 126 includes (i) a course name or course identification number; (ii) the duration of the course (e.g., time or dates the course begins and ends); (iii) the location of the course (e.g., geographic location such as city and country); (iv) the capacity of the room or location the course is offered at; and (v) the cost or fees associated with offering the course either both on a per employee basis and as a whole. In some embodiments, an entry for a course also includes one or more course reservations. The reservations are predetermined arrangements for one or more employees to enroll and take a course. An entry for a course may also include a number of reservations for certain types of employees (e.g., a number of seats are reserved for employees of a certain business unit or location). An entry for a course may also include a target composition of employees based on employee data 124. For example, a course has a target composition of 20% from Business Unit A, 30% from Business Unit B and 50% from Business Unit C. As another example, a course has a target composition of 75% managerial employees and 25% non-managerial employees. In embodiments where no target composition is provided, scheduling program 114 uses a uniform distribution.

In process 208, scheduling program 114 retrieves business data 128. In various embodiments, business data 128 includes training budgets for the business. The training budgets are also provided for each business unit or department of the business. Training budgets indicate the amount of funds available for the duration of courses being offered by the business and for which course allocation is to be determined by scheduling program 114. In some embodiments, training budgets are provided for periods smaller than the enrollment period. In such embodiments, scheduling program 114 determines the training budget for the period that a course is offered in. For example, training budgets for the four quarters of a calendar year are provided. Scheduling program 114 retrieves the corresponding quarter's budget based on the date when a course is offered (e.g., scheduling program 114 retrieves the second quarter's budget for a course offered in April). In various embodiments, business data 128 includes travel costs for each employee to travel to a location (e.g., locations where training courses are offered). Travel costs include cost for travel (e.g., train or plane tickets), average daily transportations costs at a training location (e.g., rental cars or public transportation), visa costs, average housing/hotel costs and per diems. Travel costs may be prorated based on an assumed number of employees. For example, a bus rental may be divided among the number of employees enrolled in a course. In some embodiments, travel costs may be predicted based on changes in costs stored in business data 128. The changes may be historic (e.g., a constant increase such as cost of living for a location can change predicted travel costs) or seasonal/cyclical (e.g., travel costs are greater for a given time period, such as a holiday, than others).

In process 210, scheduling program 114 retrieves scheduling model 112. Scheduling model 112 includes an objective function and one or more constraints. Scheduling program 114 receives input from a user to select a predetermined objective function and/or constraints. In some embodiments, scheduling program 114 receives input from a user to create user defined objective function and/or constraints. For example, a user gives variable names to the training information stored in database 120. The user defines objective function and one or more constraints using mathematical operators and the created variable names. Scheduling program 114 stores user created objective functions and constraints in scheduling model 112. Scheduling program 114 retrieves the selected objective function and one or more constraints, either predefined or user defined, from scheduling model 112.

The following is an example of an objective function and constraints to maximize the number of employees to be enrolled in training for the various courses offered by an organization or business, within a specified timeframe (e.g. a calendar year, a fiscal year, a quarter or a month). It is important to note, that any objective function and combination of constraints can be used without deviating from the scope of the invention. The following example uses an objective function to maximize the number of allocated employees to offered training courses. The objective function is expressed as such:

maxΣᵢΣⱼΣ_{b}ΣLZ_{ijbL} (O.1)

In the above objective, function O.1 the total number of employees allocated for courses offered by a business or organization is maximized for all offered courses, where Z_{ijbL} is the number of employees from location L and business unit b attending course i in location j. Based on the following constraints, scheduling program 114 determines the number of employees, from a specific location and business unit that can be allocated for a given course while maintaining the conditions expressed by the constraints. The following are a list of constraints to determine an optimal allocation of the number of employees, from different locations and business units, to the courses offered by a business.

ΣᵢΣⱼΣ_{L}Z_{ijbL}*C_{ijL}≦EB_{b},∀b (C.1)

In C.1, the above constraint limits the total cost of employee training for each business unit to the budget of the business unit for the set of all business units, where EB_{b} is the budget of the business unit for training and C_{ijL} is the cost of the employee from location L attending course i in location j.

Σ_{b}ΣLZ_{ijbL}≦Nᵢⱼ,∀i,j (C.2)

In C.2, the above constraint ensures the number of allocated employees at each course will not exceed the seating capacity at the location the course is offered, where Nᵢⱼ is the seating capacity of course i offered at location j.

ΣⱼZ_{ijbL}≦M_{ibL},∀i,b,L (C.3)

In C.3, the above constraint ensures that the number of corporate employees allocated to corporate training or education courses will not exceed the total number of the employees required to take the training course. Where, M_{ibL} is the number of employees in location L and business unit b that are required to attend course i, according to the employee's training plan.

Z_{ijbL}=0, ∀i; For employees j,L (C.4)

In C.4, the above constraint ensures no employees with are allocated for the set of courses i, given the employee would leave from location L and travel to location j. For example, based on employee data 124, scheduling model 112 includes constraints such as C.4 for travel combinations where a travel restriction is indicated between two countries.

Σ_{L}Z_{ijbL}=R_{ijb}; For courses i,j,b with reserves (C.5)

In C.5, the above constraint ensures that a course i at location j will reserve a number of seats for employees of business unit b, where R_{ijb} is the number of seats reserved for employees of a business unit.

Σ_{i,j}Nᵢⱼ=TC,∀i,j (C.6)

In C.6, the above constraint is the summation of the number of seats in all training courses. Where TC is the total capacity of all training courses.

ΣᵢΣⱼΣ_{L}Z_{ijbL}≦P_{b}*TC,∀b (C.7)

In C.7, the above constraint ensures the allocation of employees to training or education courses, among the different business units, is according to a pre-determined distribution. Where P_{b} is the percentage of the distribution of total training seats in all offered courses for a business unit b.

Z_{ijbL}≦0, ∀i,j,b,L (C.8)

In C.8, the above constraint ensures a positive value of employees are allocated to a course (e.g., non-negative values).

Referring back to FIGS. 2A and 2B, based on the retrieved training information (i.e., training plan data 122, employee data 124, course data 126 and business data 128) and scheduling model 112, scheduling program 114 determines an optimal solution for scheduling model 112 with the retrieved training information (process 212). In process 212, a user provides a timeframe that allocation of employees for training is to be determined. Scheduling program 114 determines an optimal solution for the objective function of scheduling model 112. Scheduling program 114 maximizes the objective function while the constraints remain feasible. Scheduling program 114 creates a set of solutions that satisfy the constraints, with the set of solutions referred to as a feasible set for the constraints. Scheduling program 114 determines a solution that maximizes the objective function using inputs for the objective function selected from the feasible set. The maximized solution of the objective function determines a maximum total number of allocations for employees to offered training courses (process 214).

Regarding the example model discussed above, based on O.1, scheduling program 114 determines a maximized allocation of the number of employees from all business units to take one or more training courses offered by a business. The selected solution satisfies the constraints C.1 to C.8. For example, the selected solution does not exceed the training budget for a business unit based on the allocation of the number of employees from the business unit to training courses (e.g., C.1). The maximized allocation determined by scheduling program 114 includes an amount of employees from each business unit and home location to be allocated to a training course offered at a location. For example, scheduling program 114 determines that thirty-five employees from business unit ‘Sales’ located at location A and fourty-six employees from business unit ‘Manufacturing’ located at location B are to be allocated to an offered course ‘New Product Line’ taught at location C.

In some embodiments, process 212 is performed by specialized hardware of computing device 110. Scheduling program 114 creates a matrix for the coefficients of the objective function and one or more matrices for the constraints of scheduling model 112. Using the example model of O.1 and C.1 to C.8 discussed above, scheduling program 114 creates a matrix for O.1 as the following:

$$[ 1 \; 1 … 1 ] [ \begin{matrix}{Z}_{1} \\ {Z}_{2} \\ … \\ {Z}_{n}\end{matrix} ] \qquad ( M .1 )$$

In M.1 above, Z₁ to Zₙ are the total number of employees attending a course taught at a location and a from a specific business unit and reporting location and n is the total number of combinations of courses taught at each location and attended by employees from all business units from each reporting location.

Scheduling program 114 creates a matrix for constraint C.1 as the following:

$$[ {C}_{1} {C}_{2} … {C}_{n} ] [ \begin{matrix}{Z}_{1} \\ {Z}_{2} \\ … \\ {Z}_{n}\end{matrix} ] \leq [ \begin{matrix}{EB}_{1} \\ {EB}_{2} \\ … \\ {EB}_{n}\end{matrix} ] \qquad ( M .2 )$$

In M.2 above, C₁ to Cₙ are the calculated costs for employees from a reporting location to attend a course taught at location and EB₁ to EBₙ is the budget for the business units corresponding to the coefficients C₁ to Cₙ.

In some embodiments, scheduling program 114 sends the matrices for the objective function and the one or more constraints to a specialized graphics processing unit (GPUs) (not shown) of computing device 110 in order to determine a optimized solution to the objective function (i.e. process 212). The specialized graphic processing unit is a specialized hardware component designed and configured to perform calculations to render images on computing device 110. The specialized graphic processing unit is has special logic circuits that are configured to perform calculations for large data sets and specifically data sets in matrix format. The specialized graphic processing unit is designed to perform dot product operations between matrices, as shown above in M.2, faster than a generic computer.

In other embodiments, process 212 is performed by a specialized logic circuit (not shown) included in computing device 110. Scheduling program 114 determines the vertices of the feasibility set (e.g., intersections of one or more constraints). The vertices are sent to the specialized logic circuit, which is configured to calculate the value of the objective function for each vertex. The specialized logic circuit retains the value of the vertex as well as the values of the vertex. For objective functions that are maximized such as O.1, if the specialized logic circuit produces a larger value for new vertex the previous value is overwritten by the specialized logic circuit. Once all vertexes have been received and the objective function's value calculated by the specialized logic circuit, the retained value is the maximized solution to the objective function based on the constraints. Examples of the specialized logic circuit include logic components (e.g., adder circuits, comparators and registers), programmable logic devices (PLDs), or Fully Programmable Gate Arrays (FPGAs) that are configured to, among other things, calculate the value of the objective function for each vertex.

Referring back to FIGS. 2A and 2B, scheduling program 114 selects employees to attend offered course based on employee availability and the optimized solution determined in processes 212 and 214 (process 216). Scheduling program 114 retrieves employee availability and other employee information (e.g., business unit and home location) from employee data 124. Scheduling program 114 selects a number of employees who are available for training on the time and/or dates of an offered course for each variable determined in the optimal solution. For example, if ten employees from business unit ‘Product Group X’ located at home location A are determined to be allocated for an offered course at location B, then scheduling program 114 selects ten employees from the indicated business unit and home location, who are required to attend this course and who are available at the dates and/or times of the offered course.

In process 218, scheduling program 114 generates an enrollment list of the selected employees. The enrollment list includes entries for each enrollment of an employee to an offered training course, the location of the offered course and the time and date the course is offered. The enrollment list may also include the home location and business unit of the employee enrolled into training. In some embodiments, the enrollment list includes travel itineraries (housing or lodging, travel arrangements, and per diem amounts). In process 220, scheduling program 114 generates a listing of training costs based on the determined enrollment list. For example, training costs are itemized based on the business units or home locations of employees. Training costs may be further broken down into fees for a course, travel costs, or lodging costs on a business unit or home location basis.

FIG. 3 depicts a block diagram, 300, of components of computing device 110 and database 120, in accordance with an illustrative embodiment of the present invention. It should be appreciated that FIG. 3 provides only an illustration of one implementation and does not imply any limitations with regard to the environments in which different embodiments may be implemented. Many modifications to the depicted environment may be made.

Computing device 110 and database 120 each include communications fabric 302, which provides communications between computer processor(s) 304, memory 306, persistent storage 308, communications unit 310, and input/output (I/O) interface(s) 312. Communications fabric 302 can be implemented with any architecture designed for passing data and/or control information between processors (such as microprocessors, communications and network processors, etc.), system memory, peripheral devices, and any other hardware components within a system. For example, communications fabric 302 can be implemented with one or more buses.

Memory 306 and persistent storage 308 are computer-readable storage media. In this embodiment, memory 306 includes random access memory (RAM) 314 and cache memory 316. In general, memory 306 can include any suitable volatile or non-volatile computer-readable storage media.

Scheduling model 112, scheduling program 114, training plan data 122, employee data 124, course data 126 and business data 128 are each stored in persistent storage 308 for execution and/or access by one or more of the respective computer processors 304 via one or more memories of memory 306. In this embodiment, persistent storage 308 includes a magnetic hard disk drive. Alternatively, or in addition to a magnetic hard disk drive, persistent storage 308 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 308 may also be removable. For example, a removable hard drive may be used for persistent storage 308. Other examples include optical and magnetic disks, thumb drives, and smart cards that are inserted into a drive for transfer onto another computer-readable storage medium that is also part of persistent storage 308.

Communications unit 310, in these examples, provides for communications with other data processing systems or devices, including resources of network 130. In these examples, communications unit 310 includes one or more network interface cards. Communications unit 310 may provide communications through the use of either or both physical and wireless communications links. Scheduling model 112, scheduling program 114, training plan data 122, employee data 124, course data 126 and business data 128 may be downloaded to persistent storage 308 through communications unit 310.

I/O interface(s) 312 allows for input and output of data with other devices that may be connected to computing device 110 and database 120. For example, I/O interface 312 may provide a connection to external devices 318 such as a keyboard, keypad, a touch screen, and/or some other suitable input device. External devices 318 can also include portable computer-readable storage media such as, for example, thumb drives, portable optical or magnetic disks, and memory cards. Software and data used to practice embodiments of the present invention, e.g., scheduling model 112, scheduling program 114, training plan data 122, employee data 124, course data 126 and business data 128, can be stored on such portable computer-readable storage media and can be loaded onto persistent storage 308 via I/O interface(s) 312. I/O interface(s) 312 also connect to a display 320.

Display 320 provides a mechanism to display data to a user and may be, for example, a computer monitor, or a television screen.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

It is to be noted that the term(s) “Smalltalk” and the like may be subject to trademark rights in various jurisdictions throughout the world and are used here only in reference to the products or services properly denominated by the marks to the extent that such trademark rights may exist.

What is claimed is:

1-7. (canceled)

8. A computer program product for allocating employees to training, the computer program product comprising:
one or more computer-readable storage media and program instructions stored on the one or more computer-readable storage media, the program instructions comprising:
program instructions to receive a plurality of offered courses for training;
program instructions to receive a first constraint for allocating employees to training, wherein the first constraint includes a first training budget for a first business unit and a second training budget for a second business unit; and
program instructions to determine a number of employees of the first business unit and a number of employees of the second business unit to be allocated to at least one of the plurality of offered courses based, at least in part, on the first training budget and the second training budget.

9. The computer program product of claim 8, wherein the number of employees allocated to the plurality of offered courses is maximized and a cost of allocating the employees of the first business unit is less than or equal to the first training budget and a cost of allocating the employees of the second business unit is less than or equal to the second training budget.

10. The computer program product of claim 9, wherein the cost of allocating the employees of the first business unit is based, at least in part, on a total travel cost for employees of the first business unit to attend the least one of the plurality of offered courses.

11. The computer program product of claim 8, the program instructions further comprising:
program instructions to receive a second constraint for allocating employees to training, wherein the second constraint includes one or more of the following: (i) a seating capacity for a course of the plurality of offered courses; (ii) a required course of an employee; (iii) one or more travel restrictions; (iv) a number of reserved seats for a course of the plurality of offered courses; and (v) a percentage of seats to be allocated to employees of a business unit to the plurality of offered courses.

12. The computer program product of claim 11, the program instructions further comprising:
program instructions to determine a set of allocations for employees of the first business unit and the second business unit, wherein the set of allocation satisfy both the first and second constraints.

13. The computer program product of claim 12, wherein the number of employees allocated to the plurality of offered courses is a maximum total number of employees of the first and second business units selected from the set of allocations.

14. The computer program product of claim 8, the program instructions further comprising:
program instructions to receive an availability of the employees allocated for training; and
program instructions to determine an enrollment of the employees allocated for training based, at least in part, on the received availability of the employees allocated for training and the determined number of employees allocated to the plurality of offered courses.

15. A computer system for allocating employees to training, the computer system comprising:
one or more computer processors;
one or more computer readable storage media; and
program instructions stored on the computer readable storage media for execution by at least one of the one or more processors, the program instructions comprising:
program instructions to receive a plurality of offered courses for training;
program instructions to receive a first constraint for allocating employees to training, wherein the first constraint includes a first training budget for a first business unit and a second training budget for a second business unit; and
program instructions to determine a number of employees of the first business unit and a number of employees of the second business unit to be allocated to at least one of the plurality of offered courses based, at least in part, on the first training budget and the second training budget.

16. The computer system of claim 15, wherein the number of employees allocated to the plurality of offered courses is maximized and a cost of allocating the employees of the first business unit is less than or equal to the first training budget and a cost of allocating the employees of the second business unit is less than or equal to the second training budget.

17. The computer system of claim 16, wherein the cost of allocating the employees of the first business unit is based, at least in part, on a total travel cost for employees of the first business unit to attend the least one of the plurality of offered courses.

18. The computer system of claim 15, the program instructions further comprising:
program instructions to receive a second constraint for allocating employees to training, wherein the second constraint includes one or more of the following: (i) a seating capacity for a course of the plurality of offered courses; (ii) a required course of an employee; (iii) one or more travel restrictions; (iv) a number of reserved seats for a course of the plurality of offered courses; and (v) a percentage of seats to be allocated to employees of a business unit to the plurality of offered courses.

19. The computer system of claim 18, the program instructions further comprising:
program instructions to determine a set of allocations for employees of the first business unit and the second business unit, wherein the set of allocation satisfy both the first and second constraints.

20. The computer system of claim 19, wherein the number of employees allocated to the plurality of offered courses is a maximum total number of employees of the first and second business units selected from the set of allocations.
